(19) United States
(12) Patent Application Publication
(10) Pub. No.: US 2026/0077672 A1
(43) Pub. Date: Mar. 19, 2026

(54) ELECTRIC DRIVE ARRANGEMENT AND METHOD FOR ITS OPERATION

(71) Applicant: MERCEDES-BENZ GROUP AG, Stuttgart (DE)

(72) Inventors: Urs BOEHME, Ehningen (DE); Markus ORNER, Rennigen (DE); Andres POTT, Esslingen (DE); Marcel SCHWINGER, Stuttgart (DE)

(21) Appl. No.: 19/330,970

(22) Filed: Sep. 17, 2025

(30) Foreign Application Priority Data
Sep. 18, 2024 (DE) 10 2024 003 020.4

(51) Int. Cl. B60L 53/62; B60L 53/10; B60L 53/16; B60L 53/22; B60L 58/18; B60L 58/27; H01M 10/42; H01M 10/46; H01M 50/249; H02J 7/00; H02M 1/42; H02M 1/44

(52) U.S. Cl. CPC B60L 53/62; B60L 53/11; B60L 53/16; B60L 53/22; B60L 58/18; B60L 58/27; H01M 10/425; H01M 10/46; H01M 50/249; H02J 7/977; B60L 2210/10; B60L 2240/545; H01M 2220/20; H02J 2207/20; H02M 1/4216; H02M 1/44

(57) ABSTRACT

When charging a high-voltage battery at a DC charging station, a first step opens charging contactors, closes switching elements, and charges the high-voltage battery via the on-board charger and to transfer charge from one partial battery to the other partial battery or vice versa by an inverter. In a second step, when the high-voltage battery has been warmed up to a predetermined target temperature by the recharging process, operation of the inverter is stopped, the charging contactors are closed and in parallel with this is charged charging via the onboard charger and charged via the charging contactors, and the on-board charger is then deactivated and the charging process continues exclusively via the charging contactors.

### CROSS-REFERENCE TO RELATED APPLICATIONS

This application claims priority under 35 U.S. C. § 119 to German Patent Application DE 10 2024 003 020.4, filed on Sep. 18, 2024, the entire disclosure of which is expressly incorporated by reference herein.

### BACKGROUND AND SUMMARY OF THE INVENTION

Exemplary embodiments of the invention relate to an electric drive arrangement for a vehicle, as well a method for its operation.

When spontaneously DC charging an electrically driven vehicle with a cold battery, only a very low charging power can be achieved, which greatly increases the charging time.

The DC fast charging time at low temperatures is determined by the battery with the maximum tolerable charging current. Damage caused by so-called plating must be avoided here. An increase in the DC charging current without damage can be implemented by heating the battery. Typical considerations in China are the charging time of the vehicle at −7° C. This is already a draft for a charging standard.

If the vehicle is aware of an imminent charging stop, for example by scheduling it in a navigation system, the temperature in the cells can be raised in good time by heating the battery while driving. This can be done, for example, via a heater in the battery cooling circuit or via an intentionally inefficient operating point in the drive during the journey (power wasting).

However, if the charging stop occurs spontaneously, it will not have been possible to heat the battery beforehand. In such cases, an impedance heating process can be used to heat the battery by transferring charge from one half of the battery to the other half and vice versa. The transfer current is controlled by the inverter. The heating occurs inside the battery cells, i.e., exactly where it is needed. The disadvantage is high electrical interference emission, which requires a very large filter to comply with legal EMC requirements.

An alternative to the impedance heating process is heating via heating mats. However, in this case the cell is only heated from the outside. A certain amount of time is therefore necessary for the cells to heat up completely. In addition, heating mats are difficult to use with round cells.

Power wasting can also be carried out when stationary during the DC charging process. The inverter provides a zero torque, but generates a high reactive current in the electric motor. The resulting heat loss in the inverter and the electric motor can be used to heat the battery via the cooling circuit. The disadvantage here is the very long dead time until the waste heat from the electric drive reaches the battery cooling plate (for example, 10 to 15 min). In addition, as with impedance heating, major EMC interference occurs, which is caused by the inverter. A filter would also be necessary here.

WO 2024/066325 A1 describes a self-heating battery circuit comprising a first battery pack, a second battery pack, a first capacitor, a second capacitor, multiple phases of bridge arms, and multiple phases of windings corresponding one-to-one to the multiple phases of bridge arms, wherein each winding phase is connected to the center of a corresponding bridge arm. A negative electrode of the first battery pack is connected to a positive electrode of the second battery pack. The negative electrode of the first battery pack and the positive electrode of the second battery pack are connected to a neutral point of the multiple phases of windings. A positive electrode of the first battery pack is connected to a first bus connection of the multiple phases of bridge arms. A negative electrode of the second battery pack is connected to a second bus connection of the multiple phases of bridge arms. A first end of the second capacitor is connected to a second end of the first capacitor. The first end of the second capacitor and the second end of the first capacitor are connected to the neutral point of the multiple winding phases. A second end of the second capacitor is connected to the negative electrode of the second battery pack. A first end of the first capacitor is connected to the positive electrode of the first battery pack.

WO 2024/045655 A1 describes a control system and a control method for the self-heating of a battery as well as an electric transport means. The control system comprises a battery pack, a winding, a first switch arrangement, a second switch arrangement, a capacitor, and a controller, wherein the battery pack comprises a first battery group and a second battery group connected in series, wherein a connection line is led out between the first battery group and the second battery group and the connection line is connected to one end of the winding, wherein the first switch arrangement and the second switch arrangement are connected in series, wherein the first switch arrangement is electrically connected to a positive electrode of the first battery group and a first end of the capacitor, and the second switch arrangement is electrically connected to a negative electrode of the second battery group and a second end of the capacitor, wherein the first end and the second end of the capacitor are used for connection to a load. A center point between the first switch arrangement and the second switch arrangement is connected to the other end of the winding. The controller is electrically connected to the first switch arrangement and the second switch arrangement such that the battery pack can generate heat.

DE 10 2011 075 927 A1 discloses a converter circuit for the multifunctional conversion of DC voltage to DC voltage, DC voltage to AC voltage, and AC voltage to DC voltage. The circuit comprises a bridge circuit with three half-bridges, chokes connected to the center nodes of the half-bridges, and a switching network. This arrangement enables flexible energy conversion and is particularly suitable for applications in the field of electromobility, such as charging and discharging batteries in electric vehicles.

Exemplary embodiments of the present invention are directed to a novel electric drive arrangement and novel method for its operation.

An electric drive arrangement for a vehicle is disclosed, comprising at least one high-voltage battery, at least one electric drive connected to the high-voltage battery, wherein the electric drive has an inverter and an electric motor. The high-voltage battery has two high-voltage connections, which can each be connected via a charging contactor to two DC charging connections for charging at a DC charging station. The high-voltage connections of the high-voltage battery are also connected to an on-board charger having a plurality of AC charging connections for connection to an AC charging station. Two of the AC charging connections can also each be connected via a switching element to one of the DC charging connections in each case. In accordance with the invention, the at least one high-voltage battery has at least a first partial battery and a second partial battery, the electric drive arrangement is configured to open the charging contactors in a first step when charging the high-voltage battery at a DC charging station, to close the switching elements, to charge the high-voltage battery via the on-board charger and to transfer charge from one partial battery to the other partial battery and/or vice versa by means of the inverter, and then, when the high-voltage battery has been warmed up to a predetermined target temperature by the recharging process, in a second step to stop operation of the inverter, close the charging contactors and charge via the charging contactors in parallel with charging via the onboard charger, and then to deactivate the on-board charger and continue the charging process exclusively via the charging contactors.

In one embodiment, the partial batteries are connected to one another in series.

In one embodiment, a center tap is provided between the partial batteries.

In one embodiment, a neutral point of the electric motor is connected to the center tap of the high-voltage battery or can be connected via a switch.

In one embodiment, the on-board charger has a power factor correction filter and a voltage converter.

In one embodiment, the voltage converter is designed as an isolating DC/DC converter.

In one embodiment, the on-board charger also has an AC EMC filter connected to the AC charging connections, and/or PFC chokes and/or a DC EMC filter connected to the high-voltage connections of the high-voltage battery. Alternatively or additionally, the voltage converter has at least one resonant choke, at least one intermediate circuit capacitor, at least one resonant capacitor and/or a transformer.

According to one aspect of the present invention, a vehicle having at least one electric drive arrangement as described above is proposed.

According to one aspect of the present invention, a method is proposed for operating the electric drive arrangement as described above when charging the high-voltage battery at a DC charging station. According to the invention, it is provided that in a first step the charging contactors are or become open, the switching elements are or become closed and the high-voltage battery is charged via the on-board charger, wherein the inverter transfers charge from one partial battery into the other partial battery and/or vice versa, wherein then, when the high-voltage battery has been heated up to a predetermined target temperature by the recharging, the operation of the inverter is stopped in a second step, the charging contactors are closed and charging is carried out via the charging contactors in parallel with charging via the on-board charger, wherein the on-board charger is then deactivated and the charging process is continued exclusively via the charging contactors.

In one embodiment, the target temperature of the high-voltage battery is selected during the transition from the first step to the second step such that the battery temperature is sufficiently high to achieve the shortest possible charging process. In particular, the target temperature is dependent on the state of charge and battery temperature. The lower the state of charge of the high-voltage battery, the higher the charging current can be selected. With regard to the battery temperature, a cold high-voltage battery has a lower permissible charging current, while a warm high-voltage battery allows a higher charging current.

By way of example, a high-voltage battery with a state of charge of 10% must be heated to approx. 0° C. until the charging contactors can be closed for charging at the DC charging station and the charging process can take place via a high DC current from the DC charging station directly to the high-voltage battery. Due to the low battery state of charge, the high-voltage battery is not damaged (e.g., because the maximum terminal voltage is not exceeded), even though the DC charging current has a high current strength. Due to the high charging current, the high-voltage battery is also heated further during the charging process and contributes to a further increase in the maximum charging current during the charging process.

If the average state of charge of the high-voltage battery is 50%, for example, the permissible charging current is reduced. If the battery is also still cold, this permissible charging current is reduced even further. At a state of charge of approx. 50%, the high-voltage battery must be heated to approx. 15° C. in order to allow a higher charging current, which is also capable of causing further heating of the battery as a result of the charging process.

Furthermore, in addition to the temperature and the state of charge, the charging currents are also dependent on the chemical composition of the battery cells. The above examples are therefore only intended as a reference value for the current state of battery cells (especially for NMC batteries).

The charging process can be carried out in two steps:

In a first step, the DC charging process takes place via the on-board charger. The charging contactors are open. The inverter is active and heats the battery by recharging (impedance heating process). The EMC interference caused by the inverter is attenuated by the filter components of the on-board charger. In a second step, the inverter stops the impedance heating process as soon as the battery has been heated to a target value. The charger initially remains in operation. The charging contactors are closed and part of the charging current can flow in parallel to the on-board charger due to the direct coupling of the charging column with the vehicle battery. The on-board charger can now be deactivated.

The solution according to the invention makes it possible to accelerate the charging process at low temperatures compared to the battery heating process by heating the cooling water (heater or power wasting in the electric drive) or by using heating mats. An EMC filter can be avoided or greatly reduced in size.

The invention is aimed at the possibility of carrying out an impedance heating process during the DC charging process. This is intended to make it clear to the customer that the charging process has started (low DC charging current sets in) and a predicted charging time can be communicated to the customer by the vehicle.

Exemplary embodiments of the invention are explained in more detail below with reference to a drawing.

### BRIEF DESCRIPTION OF THE SOLE DRAWING FIGURE

The sole drawing FIGURE is a schematic view of an electric drive arrangement of a vehicle.

### DETAILED DESCRIPTION

The sole is a schematic view of an electric drive arrangement 1 of a vehicle, for example a passenger car, a commercial vehicle, or a bus.

The electric drive arrangement 1 has a high-voltage battery 2, which is constructed from a series connection of a first partial battery 3 and a second partial battery 4 with a center tap between the partial batteries 3, 4. Furthermore, at least one electric drive is provided, comprising an inverter 5 and an electric motor 6 (symbolized here by three inductances L1, L2, L3 of a stator), which is connected to the high-voltage battery 2. A neutral point 15 of the electric motor 6 is connected to the center tap of the high-voltage battery 2. The high-voltage battery 2 has two high-voltage connections, each of which can be connected via a charging contactor 8, 9 to DC charging connections EVSE_P, EVSE_N for charging at a DC charging station EVSE in order to charge the high-voltage battery 2.

The high-voltage connections of the high-voltage battery 2 are also connected to an on-board charger 7, which has AC charging connections U, V, W for connection to an AC charging station in order to charge the high-voltage battery 2.

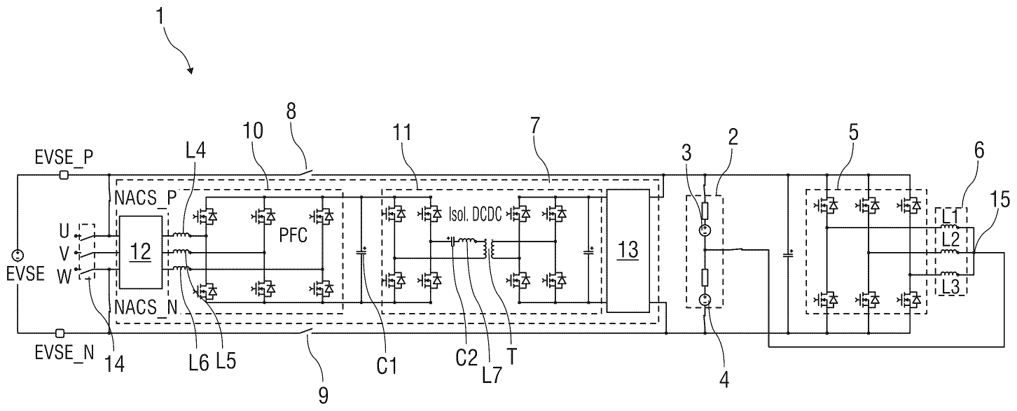

The topology of the on-board charger 7 shown in FIG. 1 is exemplary and has a power factor correction filter 10 and a voltage converter 11, for example an isolating DC/DC converter 11, as well as EMC-effective subcomponents, including an AC filter 12 or AC EMC filter 12, which is connected to the AC charging connections U, V, W; inductances, such as PFC chokes L4, L5, L6 and/or at least one resonant choke L7; capacitances, such as at least one intermediate circuit capacitor C1 and/or a resonant capacitor C2, a transformer T and a DC EMC filter 13, which is connected to the high-voltage connections of the high-voltage battery 2. Two of the AC charging connections U, V, W can also each be connected to one of the DC charging connections EVSE_P, EVSE_N via a switching element NACS_P, NACS_N.

The charging process is divided into two time periods:

In a first step, the vehicle is DC-charged via the on-board charger 7. The charging contactors 8, 9 are opened. The DC charging station EVSE is connected to the high-voltage system of the vehicle via the closed switching elements NACS_P and NACS_N and the on-board charger 7. A voltage disconnection 14 of the AC charging connections U, V, W is open. The inverter 5 is active and transfers charge from one partial battery 3, 4 into the other partial battery 3, 4 and/or vice versa, for example using the impedance heating method known in the prior art. EMC interference from the inverter 5 is prevented from propagating via the DC charging cable to the DC charging station EVSE by the open charging contactors 8, 9 and the filter effect of the on-board charger 7 with its subcomponents, in particular the DC EMC filter 13, the transformer T, the LC elements (low-pass filters) consisting of resonant choke L7 and resonant capacitor C2, the AC EMC filter 12, or is strongly attenuated.

In this case, the charging power to the high-voltage battery 2 is the AC charging power of the on-board charger 7 minus a power loss in the electric drive and in the high-voltage battery 2.

In a second step, the charging contactors 8, 9 are closed and DC charging is continued directly from the DC charging station EVSE via the charging contactors 8,9 to the high-voltage battery 2. When the high-voltage battery 2 has been heated to a predetermined target temperature by the impedance heating process, operation of the inverter 5 is stopped. Charging continues via the on-board charger 7 in order to avoid a charging interruption due to an interruption in the charging current. Parallel to charging via the on-board charger 7, the charging contactors 8, 9 are closed, whereby the DC charging station EVSE is now coupled directly to the high-voltage battery 2 as a parallel path. The on-board charger 7 is then deactivated and the charging process takes place exclusively via the charging contactors 8, 9. The target temperature of the high-voltage battery 2 during the transition from the first step to the second step can be selected such that the battery temperature is sufficiently high to achieve the shortest possible charging process, i.e. battery heating due to the DC charging process with the high DC charging current can also be taken into account.

The following additional components are required compared to a conventional impedance heating process including EMC filter:
voltage disconnection 14 of the AC charging connections U, V, W,
switching elements NACS_P and NACS_N for connecting the DC charging station EVSE to the on-board charger 7.

### REFERENCE NUMERAL LIST

1 drive arrangement
2 high-voltage battery
3 partial battery
4 partial battery
5 inverter
6 electric motor
7 on-board charger
8 charging contactor
9 charging contactor
10 power factor correction filter
11 voltage converter, DC/DC converter
12 AC filter, AC EMC filter
13 DC EMC filter
14 voltage disconnection
15 neutral point
C1 intermediate circuit capacitor
C2 resonant capacitor
EVSE DC charging station
EVSE_N DC charging connection
EVSE_P DC charging connection
L1, L2, L3 inductance
L4, L5, L6 PFC choke
L7 resonant choke
NACS_N switching element
NACS_P switching element
T transformer
U, V, W AC charging connection

What is claimed is:

1. An electric drive arrangement for a vehicle, the electric drive arrangement comprising:
a high-voltage battery comprising two high-voltage connections respectively connectable via a respective one of two charging contactors to two DC charging connections of a DC charging station and having at least a first partial battery and a second partial battery;
an electric drive connected to the high-voltage battery, wherein the electric drive comprises an inverter and an electric motor; and
an on-board charger connected to the two high-voltage connections and comprising a plurality of AC charging connections configured to connect to an AC charging station, wherein two of the plurality of AC charging connections are also connectable via a respective one of two switching elements to a respective one of the two DC charging connections,
wherein the electric drive arrangement is configured when charging the high-voltage battery at the DC charging station to
first open the two charging contactors, close the two switching elements, charge the high-voltage battery via the on-board charger and transfer charge, using the inverter, from one of the first and second partial batteries to another one of the first and second partial batteries, and then
when the high-voltage battery is warmed to a predetermined target temperature by the charging the high-voltage battery via the on-board charger, stop operation of the inverter, close the two charging contactors, and charge the high-voltage battery via the charging contactors in parallel with charging via the on-board charger, and then to deactivate the on-board charger and continue to charge the high-voltage battery exclusively via the charging contactors.

2. The electric drive arrangement of claim 1, wherein the first and second partial batteries are connected to one another in series.

3. The electric drive arrangement of claim 2, wherein there is a center tap between the first and second partial batteries.

4. The electric drive arrangement of claim 3, wherein
a neutral point of the electric motor is connected to the center tap of the high-voltage battery, or
the neutral point of the electric motor is connectable via a switch to the center tap of the high-voltage battery.

5. The electric drive arrangement of claim 1, wherein the on-board charger comprises a power factor correction filter and a voltage converter.

6. The electric drive arrangement of claim 5, wherein the voltage converter is an isolating DC/DC converter.

7. The electric drive arrangement of claim 5, wherein
the on-board charger further comprises an AC EMC filter connected to the AC charging connections, PFC chokes or a DC EMC filter, which is connected to the two high-voltage connections of the high-voltage battery, or
the voltage converter has at least one resonant choke, at least one intermediate circuit capacitor, at least one resonant capacitor or a transformer.

8. A vehicle comprising:
an electric drive arrangement, which comprises
a high-voltage battery comprising two high-voltage connections respectively connectable via a respective one of two charging contactors to two DC charging connections of a DC charging station and having at least a first partial battery and a second partial battery;
at least one electric drive connected to the high-voltage battery, wherein the electric drive comprises an inverter and an electric motor; and
an on-board charger connected to the two high-voltage connections and comprising a plurality of AC charging connections configured to connect to an AC charging station, wherein two of the plurality of AC charging connections are also connectable via a respective one of two switching elements to a respective one of the two DC charging connections,
wherein the electric drive arrangement is configured when charging the high-voltage battery at the DC charging station to
first open the two charging contactors, close the two switching elements, charge the high-voltage battery via the on-board charger and transfer charge, using the inverter, from one of the first and second partial batteries to another one of the first and second partial batteries, and then
when the high-voltage battery is warmed to a predetermined target temperature by the charging the high-voltage battery via the on-board charger, stop operation of the inverter, close the two charging contactors, and charge the high-voltage battery via the charging contactors in parallel with charging via the on-board charger, and then to deactivate the on-board charger and continue to charge the high-voltage battery exclusively via the charging contactors.

9. A method for operating an electric drive arrangement of a vehicle when charging a high-voltage battery, comprising first and second partial batteries, of the vehicle at a DC charging station, the electric drive arrangement further comprising an electric drive, the method comprising:
in a first step
opening charging contactors of the high-voltage battery,
close two switching elements of the electric drive arrangement,
charge the high-voltage battery via an on-board charger of the electric drive arrangement, and
transfer charge, using an inverter of the electric drive, from one of the first and second partial batteries to another one of the first and second partial batteries,
wherein the two charging contactors respectively connect one of two high-voltage connections of the high-voltage battery to two DC charging connections of the DC charging station,
wherein the on-board charger is connected to the two high-voltage connections and comprises a plurality of AC charging connections configured to connect to an AC charging station, and
wherein two of the plurality of AC charging connections are also connectable via a respective one of the two switching elements to a respective one of the two DC charging connections; and
in a second step subsequent to the first step and when the high-voltage battery has been heated up to a predetermined target temperature by the charging of the high-voltage battery by the on-board charger,
stopping operation of the inverter,
closing the two charging contactors, and
performing charging via the two charging contactors in parallel with charging via the on-board charger, wherein the on-board charger is then deactivated and the charging of the high-voltage battery continues exclusively via the two charging contactors.

10. The method of claim 9, wherein the predetermined target temperature of the high-voltage battery is selected during a transition from the first step to the second step such that the predetermined target battery temperature is sufficiently high to achieve a shortest possible charging process.
